(19) United States
(12) Patent Application Publication
(10) Pub. No.: US 2008/0137265 A1
(43) Pub. Date: Jun. 12, 2008

(54) High voltage non-toxic electrolytes for ultracapacitors

(76) Inventor: Sagar N. Venkateswaran, Glen Mills, PA (US)

Correspondence Address: SAGAR N. VENKATESWARAN, 9 Thomas Speakman Drive, Glen Mills, PA, 19342, US

(21) Appl. No.: 11/637,571

(22) Filed: Dec. 12, 2006

(51) Int. Cl. H01G 9/00; H01G 9/02

(52) U.S. Cl. 361/502; 252/62.2

(57) ABSTRACT

Novel high voltage, non-toxic electrolytes for ultracapacitors, and high volumetric and gravimetric energy density ultracapacitors are disclosed herein, which provide substantial improvements in hybrid electric systems.

### CROSS REFERENCE TO RELATED DOCUMENTS

The subject matter of the invention is described in part in the Disclosure Document of Sagar N. Venkateswaran Serial No. 567,018 filed on Dec. 20, 2004 and titled “High Voltage Non-toxic Electrolytes for Ultracapacitors.”

### BACKGROUND OF THE INVENTION

Prior art ultracapacitors, also called double layer capacitors or supercapacitors utilize high surface area activated carbon in their electrodes and mostly one mole (1 M) solution of Tetraethylammonium tetrafluorborate (TEABF₄) salt in dry acetonitrile (AN) as electrolyte. The breakdown of AN at voltages greater than 2.5V, limits the energy density of these capacitors to 4-5 Wh/Kg and Wh/L (Maxwell, Ness and Panasonic). AN is also very toxic and flammable. Therefore, it is desirable to develop new electrolytes to improve the energy density and safety. The present invention is directed to high voltage non-toxic and safer electrolytes. Attempts have been made by others to eliminate the toxicity by using non-acetonitrile solvents. Examples of such electrolytes based on propylene carbonate (PC), gamma-butyrolactone (GBL), ethylene carbonate (EC), dimethyl carbonate (DMC), and their mixtures are described in the U.S. Pat. No. 6,256,190 of Wei et al. Their conductivities are about ⅓ of AN based electrolytes, due to only 1 M TEABF₄ loading. However, there is no suggestion of using higher voltages and higher molar loading in this patent to increase the energy density, and no suggestion to use solvents capable of low temperature operation.

Other quartenary onium salts have been also tried as described in the Journal of Electrochemical Society Pages 2989-2995, Vol. 141 (1994).

Some of these salts, such as triethylmethylammonium and ethylmethylpyrrolidinium tetrafluoroborate (TEMABF₄) and (EMPBF₄) have higher conductivity than the symmetrical TEABF₄, due to their greater solubility. However, optimum mixes of solvents for voltages greater than 3.7V, low temperature operation and higher molar concentrations than 1 to achieve higher capacity and higher energy density, are not suggested in this article.

Ionic liquids, described in the Journal of Fluorine Chemistry Pages 135-141, 120 (2003), such as 1-alkyl-3-methylimidazolium tetrafluoroborate (EMIBF₄) mixed with PC, achieved some enhancement of conductivity over the TEMABF₄, but this mixture has a low temperature operational limit, of only −15° C.

It is well known, that various mixtures of aprotic organic solvents, such as EC+DMC+EMC, and EC+EMC (where EMC=ethylmethyl carbonate) are used in lithium-ion batteries together with lithium salts, such as LiPF₆ and LiBF₄, and that they can operate up to 4.5V without decomposing, and that these mixtures can operate at very low temperature (−40° C.). However, no one suggested that these specific solvents' mixtures can be used in 4-4.5V single cell ultracapacitors, when the lithium salts are replaced with TEABF₄, and/or TEMABF₄, and/or EMPBF₄, and/or ionic liquids. Electrolytes of the instant invention do not suffer from prior art problems and provide many positive advantages.

### SUMMARY OF THE INVENTION

It has now been found, that novel electrolytes described below increase capacity and energy density of ultracapacitors by higher molar concentrations of salts and by being able to operate at higher voltages than prior art electrolytes. They also eliminate toxicity. The electrolytes of the invention are non-toxic and can operate at −40° C., from 0V to 4.5V, and more preferably 0V to 4.0V, depending on cycle life required. The lower voltage of course extends the cycle life. It has also been found, that higher molar salt loading increases not only ionic conductivity, but also capacity, which results also in higher energy density. The higher voltage increases the energy density (Wh=Ah×V), and compensates for slightly lower conductivity (=lower rate capability in Amps) of these electrolytes. The volumetric energy density of high voltage series string of these ultracapacitors having electrolytes of the invention is substantially increased, due to fewer number of cells required for the final voltage. Fewer number of cells also means less I 2.R losses from interconnects and less complex balancing control circuitry. Ultracapacitor energy is also increased by the higher voltage with the square of the voltage value.

In combination, the volume, weight, quantity, and cost of the components is thus reduced by at least %, while having same Farads.

I have found that the best results as described above are provided by these specific ultracapacitor electrolytes:
1. 2-3 M TEMABF₄ in GBL/EMC (3:2)
2. 2-3 M EMPBF₄ in GBL/EMC (3:2)
3. 2-6 M EMIBF₄ in GBL/EMC (3:2)
4. 1.2 M TEABF₄ in EC/EMC (3:2)
5. 2-3 M TEMABF₄ in EC/EMC (3:2)
6. 2-3 M EMPBF₄ in EC/EMC (3:2)
7. 2-6 M EMBF₄ in EC/EMC (3:2)
8. 2-3 M TEMABF₄ in EC/DMC/EMC (6:3:1)
9. 2-3 M EMPBF₄ in EC/DMC/EMC (6:3:1)
10. 2-6 M EMIBF₄ in EC/DMC/EMC (6:3:1)
11. 2-3 M TEMABF₄ in EC/GBL/EMC (6:3.5:0.5)
12. 2-3 M EMPBF₄ in EC/GBL/EMC (6:3.5:0.5)
13. 2-6 M EMIBF₄ in EC/GBL/EMC (6:3.5:0.5)
14. 2-3 M LiBF₄ in EC/EMC (1:4)

Where M is mole; TEMABF₄ is triethylmethylammonium tetrafluoroborate; EMPBF₄ is ethylmethylpyrrolidinium tetrafluoroborate; EMIBF₄ is 1-alkyl-3 methylimidazolium tetrafluroborate; TEABF₄ is tetraethylammonium tetrafluroborate; LiBF₄ is lithium tetrafluroborate; GBL is gamma-butyrolactone; EMC is ethylmethyl carbonate; EC is ethylene carbonate, and DMC is diethylmethyl carbonate. Ratios are by weight percent. The BF₄ is preferred anion over the PF₆ and others cited in the prior art.

It should be noted, that the electrolytes 11-13 are also flame retardant and safer.

EMC is the critical component in all mixtures to ensure low temperature operation and low viscosity.

The principal object of the invention is to provide electrolytes which result in a higher gravimetric and volumetric energy density of ultracapacitors over the prior art electrolytes and ultracapacitors.

Another object of this invention is to provide non-toxic and safer electrolytes for ultracapacitors.

Another object of this invention is to provide electrolytes for ultracapacitors, which can operate at very low temperatures.

Other objects and advantageous features of the invention will be apparent from the description and claims.

### BRIEF DESCRIPTION OF THE DRAWINGS

The present invention will be described with reference to the accompanying drawing of which:

FIG. 1 is a graph showing one typical example of the voltage span achieved with the electrolytes of the invention in a laboratory test cell A.

FIG. 2 is a graph showing another typical example of the voltage span achieved with the electrolytes of the invention in another laboratory test cell B.

### DETAILED DESCRIPTION OF THE PREFERRED EMBODIMENTS

When referring to the preferred embodiments, certain terminology will be utilized for the sake of clarity. Use of such terminology is intended to encompass not only the described embodiments, but also technical equivalents which operate and function in substantially the same way to bring about the same result.

Ultracapacitor cell usually comprises high surface porous positive and negative electrodes with a porous separator therebetween, all saturated with various liquid electrolytes and enclosed in a hermetically sealed enclosure with sealed positive and negative terminals connected to the electrodes and exiting from the enclosure, (not shown). The cell may be rolled cylindrical, or flat. Flat prismatic ultracapacitors may also have several flat cells stacked in one enclosure and electrically connected in parallel to increase capacitance. The electrolytes for non-aqueous ultracapacitors and ultracapacitors having such electrolytes, are the subjects of this invention.

Referring now to the high voltage, non-toxic, low temperature, non-aqueous electrolyte compositions for high energy density symmetric ultracapacitors, one embodiment of the electrolyte is a mixture of gamma-butyrolactone (GBL) and ethylmethyl carbonate (EMC) with triethylmethylammonium tetrafluoroborate (TEMABF₄) salt. 2-3 molar TEMABF₄ in 50%-70% (weight percent) of GBL and 30%-50% (weight percent) of EMC ratio is the preferred composition.

Another embodiment of the electrolyte is a mixture of GBL and EMC in the same weight ranges as described above, but the salt is 2-3 moles ethylmethylpyrrolidinium tetrafluorocarbonate (EMPBF₄).

Another embodiment of the electrolyte is a mixture of GBL and EMC in the same weight ranges as described above, but the salt is 2-6 moles ionic liquid, such as 1-alkyl-3-methylimidazolium tetrafluroborate (EMIBF₄).

Another embodiment of the electrolyte is a mixture of GBL and EMC in the same weight ranges as described above, but the salt is 1.2 moles tetraethylammonium tetrafluroborate (TEABF₄), as described in my Disclosure Document Ser. No. 567,018, filed on Dec. 20, 2004.

It should be noted, that these specific and unique combinations of solvents and salts above are not disclosed in prior art and especially with the higher molar loading to achieve higher energy density and capacitance.

Another embodiment of the invention is the electrolyte composition comprising a mixture of ethylene carbonate (EC) and EMC with TEMABF₄ salt. 2-3 molar TEMABF₄ in 50%-70% (weight percent) of EC and 30%-50% (weight percent) of EMC ratio is the preferred composition.

Another embodiment of the electrolyte is a mixture of EC and EMC in the same weight % ranges (50%-70% EC) and (30%-50% EMC), but the salt is 2-3 moles EMPBF₄.

Another embodiment of the electrolyte is a mixture of EC and EMC in the same weight % ranges (50%-70% EC) and (30%-50% EMC), but the salt is 2-6 moles EMIBF₄.

It should be also noted that EMC is the critical component in all mixtures to ensure low temperature operation (to −40° C.), and low viscosity. This is another embodiment of the invention.

Another embodiment of the invention is the electrolyte composition comprising a mixture of EC, dimethyl carbonate (DMC), and EMC with TEMABF₄ salt. 2-3 molar TEMABF₄ in 50%-70% (weight percent) of EC, 20%-40% (weight percent) of DMC, and 1%-20% (weight percent) of EMC ratio is the preferred composition.

Another embodiment of the electrolyte is a mixture of EC, DMC, and EMC in the same weight percent ranges (50%-70% EC; 20%-40% DMC; 1%-20% EMC) as above, but the salt is 2-3 moles EMPBF₄.

Another embodiment of the electrolyte is a mixture of EC, DMC, and EMC in the same weight percent ranges (50%-70% EC; 20%-40% DMC; 1%-20% EMC) as above, but the salt is 2-6 moles EMIBF₄.

It should be noted that in these last three mixtures there is no cyclic ester present.

Another embodiment of the electrolyte is a mixture of EC, GBL, and EMC with TEMABF₄ salt. 2-3 moles TEMABF₄ in 50%-70% (weight percent) of EC; 28%-38% (weight percent) of; GBL; and 1%-10% (weight percent) of EMC ratio is the preferred composition, but the EMC (weight percent) range also may be from trace amounts to 10%.

Another embodiment of the electrolyte is a mixture of EC, GBL, and EMC in the same weight percent ranges (50%-70% EC; 28%-38% GBL; 1%-10% EMC) as above, but the salt is 2-3 moles EMPBF₄. The EMC may be also from trace amounts to 10%.

Another embodiment of the electrolyte is a mixture of EC, GML, and EMC in the same % ranges (50%-70% EC; 28%-38% GBL; 1%-10% EMC) as above, but the salt is 2-6 moles EMBF₄. The EMC may be also from trace amounts to 10%.

Although Wei et al. in the U.S. Pat. No. 6,256,190 indirectly disclosed a similar tertiary solvents' mixture, it should be noted that different salts are used herein with much higher molar loading to provide superior energy density and capacitance.

If the EMC in the last three compositions is kept less than 2%, the described electrolytes are also flame retardant, which makes them safer.

Another embodiment of the electrolyte, which is also useful for asymmetric ultracapacitors is a mixture of EC and EMC with LiBF₄ salt, as described in my prior Disclosure Document Ser. No. 567,018 filed on Dec. 20, 2004. The preferred ratio is 15%-30% (weight percent) of EC and 70%-90% (weight percent) of EMC with 2-3 moles LiPF₄ salt.

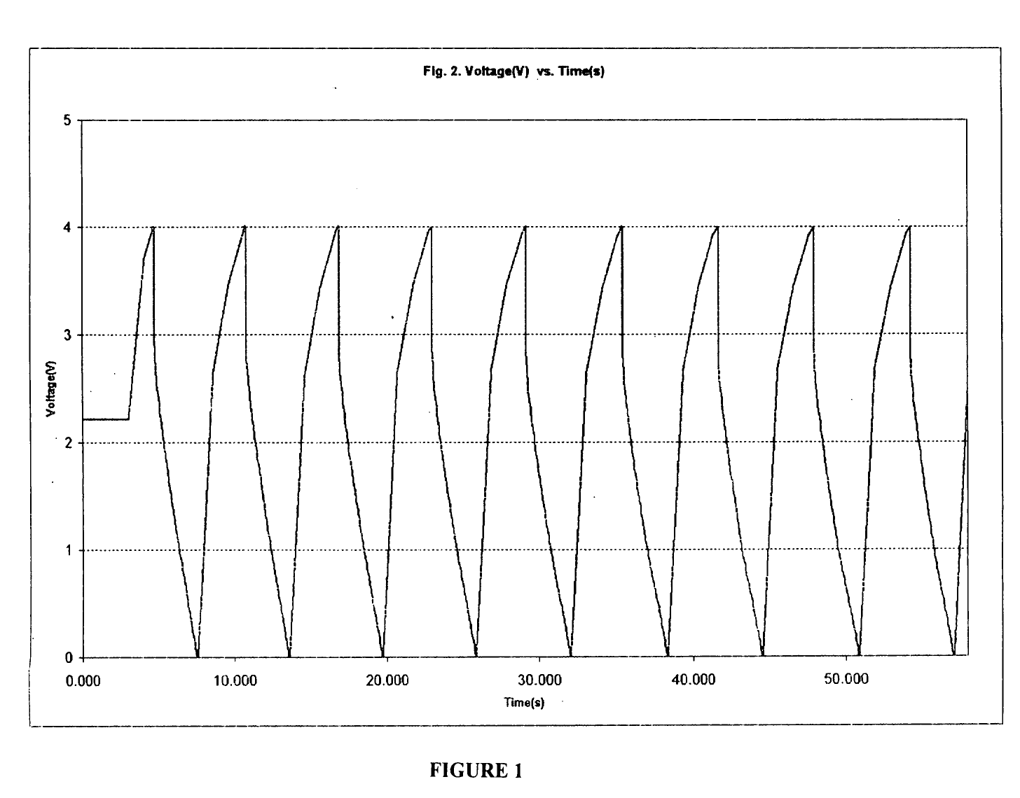

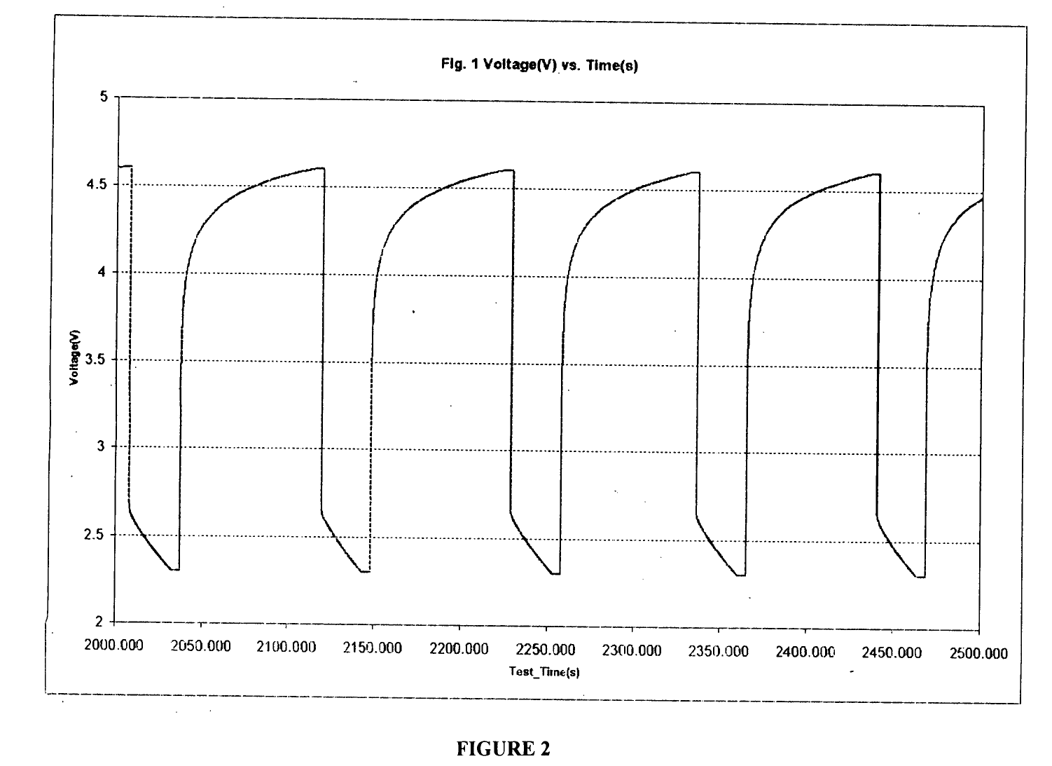

All above electrolytes can be also mixed and can operate at low temperatures down to −40° C., and have operational voltage span from 0V to 4.5V, and more preferably from 0V to 4.0V, as shown in typical examples in FIGS. 1 and 2. Lower top voltages, such as 3.0V-3.7V can be also used. It has now been found, that the higher molar salt concentrations as described, not only increase the ionic conductivity, but also increase capacity, which results in a higher energy density. This is another embodiment of the invention. Apparently, when the larger amount of the salt is split upon charge into anions and cations on the electrodes, it stores and provides more energy per the cell weight when discharged. Additionally, the described higher voltage provides more energy, as per formula E=½C×V², where C=capacitance and V=volts. Because the voltage effects the energy with the square of the value, the operating voltage increase more than compensates for the lower conductivity of these electrolytes relative to AN-based electrolytes. Unlike AN based electrolytes, the above electrolytes do not require special leak-proof packaging, which results in weight savings, and installations in locations not possible with AN presence. The net result of using the above electrolytes of the invention is more energy available, with no toxicity and more safety.

In a series cell pack, the volumetric energy density is also increased, due to the fewer cells required for the desired final voltage. The capacity of the cell increases about 50% due to the higher molar concentration, and the energy due to voltage increases about 100%. The net result is the weight and volume of the ultracapacitor cell approximate reduction to 33% per Farad of the prior art ultracapacitor cell, which makes the electrolytes and ultracapacitors of the invention practical for use in hybrid electric vehicles and other applications.

It will thus be seen, that the electrolytes have been provided, with which the objects of the invention are achieved.

I claim:

1. A high voltage stable and non-toxic electrolyte for ultracapacitors which comprises:
2.0 to 3.0 molar concentration of a quaternary fluoroborate onium salt in the mixture of gamma-butyrolactone ethylmethyl carbonate in the range of 50 to 70% by weight percentage, and ethylmethyl carbonate in the range of 30% to 50% by weight percentage.

2. A high voltage stable and non-toxic electrolyte for ultracapacitors which comprises:
2.0 to 3.0 molar concentration of a quaternary fluoroborate onium salt in the mixture of ethylene carbonate in the range of 50 to 70% by weight percentage, and ethylmethyl carbonate in the range of 30 to 50% by weight percentage.

3. A high voltage stable and non-toxic electrolyte for ultracapacitors which comprises:
2.0 to 3.0 molar concentration of a quaternary fluroborate onium salt in the mixture of ethylene carbonate in the range of 50 to 70% by weight percentage, and diethylmethyl carbonate in the range of 20 to 40% by weight percentage, and ethylmethyl carbonate in the range of 1 to 20% by weight percentage.

4. A high voltage stable and non-toxic electrolyte for ultracapacitors which comprises:
2.0 to 3.0 molar concentration of a quaternary fluoroborate onium salt in the mixture of ethylene carbonate in the range of 50 to 70% by weight percentage, and gamma-butyrolactone in the range of 28 to 38% by weight percentage, and ethylmethyl carbonate in the range from trace amounts to 10% by weight percentage.

5. A high voltage stable and non-toxic electrolyte for ultracapacitors which comprises:
2.0 to 3.0 molar concentration of lithium tetrafluroborate salt in the mixture of ethylene carbonate in the range of 10 to 30% by weight percentage, and ethylmethyl carbonate in the range of 70 to 90% by weight percentage.

6. A high voltage stable and non-toxic electrolyte for ultracapacitors, which comprises a mixture of electrolytes as described in claims 1-5 inclusive, and as described in claim 10.

7. A high voltage stable and non-toxic electrolyte for ultracapacitors as described in claims 1-4 inclusive, in which said quaternary fluoroborate onium salt is triethylmethylammonium tetrafluoroborate.

8. A high voltage stable and non-toxic electrolyte for ultracapacitors as described in claims 1-4 inclusive, in which said quaternary fluoroborate onium salt is ethylmethylpyrrolidinium tetrafluoroborate.

9. A high voltage stable and non-toxic electrolyte for ultracapacitors as described in claims 1-4 inclusive, in which said quaternary fluoroborate onium salt is 1-alkyl-3 methylimidazolium tetrafluoroborate.

10. A high voltage stable and non-toxic electrolyte for ultracapacitors which comprises 1.0 to 1.5 molar concentration of tetraethylammonium tetrafluoroborate in the mixture of gamma-butyrolactone in the range of 50 to 70% by weight percentage, and ethylmethyl carbonate in the range of 30 to 50% by weight percentage.

11. A high voltage stable non-toxic electrolyte as described in claim 4, which can be made flame retardant by having less than 2% ethylmethyl carbonate.

12. A high voltage stable and non-toxic electrolyte for ultracapacitors, as described in claims 1-5 inclusive and as described in claim 10, which can operate at low temperatures, down to −40° C.

13. A symmetric ultracapacitor having an electrolyte therein, as described in claims 1-5 inclusive, and as described in claim 10.

14. An asymmetric ultracapacitor having an electrolyte therein, as described in claim 5.

15. A high voltage multi-celled ultracapacitor pack containing ultracapacitors as described in claim 13, electrically connected in series.
